(19) United States
(12) Patent Application Publication
(10) Pub. No.: US 2023/0389579 A1
(43) Pub. Date: Dec. 7, 2023

(54) METHOD OF COOKING A COOKING PRODUCT IN A DETERMINED COOKING TIME

(71) Applicant: Topinox Sarl, Wittenheim (FR)

(72) Inventors: Martin HEINRICH, Wittenheim (FR); Phillip VAN HALSEMA, Wittenheim (FR)

(21) Appl. No.: 18/205,458

(22) Filed: Jun. 2, 2023

(30) Foreign Application Priority Data
Jun. 3, 2022 (DE) 10 2022 114 160.8

(51) Int. Cl. A23L 5/10; H05B 6/64; F24C 1/04

(52) U.S. Cl. CPC A23L 5/15; H05B 6/647; F24C 1/04

(57) ABSTRACT

A method of cooking a cooking product using at least two different energy sources for cooking the cooking product, involves the following steps of selecting a cooking path by means of which the cooking product to be cooked is cooked, wherein the cooking path comprises a total energy to be introduced, which is to be introduced into the cooking product by the at least two different energy sources, and wherein the cooking path comprises a target temperature profile of a cooking product core; determining an actual temperature of the cooking product core during an ongoing cooking process; and regulating at least one of the two energy sources on the basis of the at least one target temperature profile of the core temperature and the actual temperature of the core temperature, taking the total energy to be introduced into account, such that the total energy to be introduced is maintained.

### FIELD OF THE DISCLOSURE

Embodiments of the present disclosure relate to a method of cooking a cooking product using at least two different energy sources for cooking the cooking product, the energy inputs of which into the cooking product have different penetration depths. Furthermore, embodiments of the present disclosure relate to a cooking appliance.

### BACKGROUND

In professional or large-scale catering establishments, cooking appliances are used which can cook a cooking product placed in a cooking chamber of the cooking appliance in different ways. In addition to the conventional methods which use hot air and/or steam (convection) to cook the cooking product, modern cooking appliances frequently also use microwave sources which introduce energy into the cooking product by means of electromagnetic radiation, causing it to heat up. Magnetrons as well as semiconductor components can be used as microwave sources for electromagnetic radiation (microwaves).

It is known that cooking appliances having a plurality of different energy sources can be used to reduce the cooking time and/or improve the cooking result. Cooking of the cooking product then takes place using a mix of energy from the individual energy sources.

Here, it is desirable that the internal doneness and the external doneness are achieved simultaneously, i.e. that both a desired core temperature and crust formation and/or surface temperature of the cooking product are present at the same time, in particular the end time of the cooking process.

If, in addition, energy types having different penetration depths into the cooking product are used when heating food, the surface and the interior of the product can be heated at least partially decoupled from each other or energy can be introduced purposefully into the interior of the product and into the outer layer of the cooking product. For example, convection can be used to heat the surface, infrared radiation (penetration depth of a few millimeters) can be used to heat an area close to the surface, and microwave radiation (penetration depth of about 2 to 3 cm) can be used to purposefully heat an inner area of the cooking product.

However, the methods and appliances known so far offer no or only very limited possibilities to combine two or more types of energy via the introduced energy amounts thereof to find an optimal compromise of the energy mix with respect to the required or desired cooking result within a defined time.

### SUMMARY

The object of the present disclosure is therefore to provide a simple and cost-effective way of using two or more types of energy or available energy sources having different penetration depths in a cooking process such that an optimum result is achieved in terms of cooking quality and cooking time.

According to the present disclosure, the object is achieved by a method of cooking a cooking product using at least two different energy sources for cooking the cooking product, the energy inputs of which into the cooking product have different penetration depths. The method comprises at least the following steps:
selecting a cooking path by means of which the cooking product to be cooked is cooked, wherein the cooking path comprises a total energy to be introduced, which is to be introduced into the cooking product by the at least two different energy sources, and wherein the cooking path comprises a target temperature profile of a cooking product core;
determining an actual temperature of the cooking product core during an ongoing cooking process; and
regulating at least one of the two energy sources on the basis of the at least one target temperature profile of the core temperature and the actual temperature of the core temperature, taking the total energy to be introduced into account, such that the total energy to be introduced is maintained.

The basic idea is to distribute the amount of energy required to achieve the desired cooking result among the individual energy sources dynamically during the cooking process, i.e., as a function of the core temperature of the cooking product. If, when determining the core temperature, it is found that this is below a current target temperature, the energy output of the energy source having a higher penetration depth can be increased or the energy source having a higher penetration depth can be regulated up accordingly. At the same time, the energy introduced by means of the other energy source(s) and/or the cooking time can be adjusted accordingly so that the total energy to be introduced is maintained. It is thus ensured that the desired external doneness as well as the desired internal doneness are achieved simultaneously. In other words, it is provided in accordance with the present disclosure to use the core temperature of the cooking product during the cooking process as a reference variable to obtain information about the internal doneness of the cooking product. Based on the information obtained, at least one of the two energy sources is then regulated to ensure that the cooking product achieves the desired cooking result at the same time, which relates both the internal doneness and the external doneness. This is ensured as the total energy to be introduced overall into the cooking product, i.e. the total amount of energy to be introduced by the energy sources, has been introduced into the cooking product after the cooking process has been completed. Here, the cooking time provided in the selected cooking path may remain unchanged or may be changed.

In particular, selecting the cooking path may involve specifying a desired cooking result, actual or target parameters of the cooking product, in particular of the internal and/or external doneness, a type of cooking product, and/or a desired cooking time. The cooking path to be processed is then selected from one or more of these setting parameters or a stored cooking path is modified on the basis of the set setting parameters.

The cooking path comprises at least a total energy to be introduced into the cooking product and a target temperature profile of a cooking product core. Of course, this is not to be understood in a restrictive manner. The cooking path may include further specifications and/or parameters, for example a desired surface temperature profile, a target temperature profile in the cooking chamber or a desired cooking chamber atmosphere with a defined humidity.

The target values and/or target profiles included in the cooking path may already be stored, for example in a memory of the cooking appliance.

Basically, control commands for components of the cooking appliance are stored in a cooking program that is processed by a processor of the cooking appliance during the cooking process. The control commands are implemented by the processor, which then controls the components of the cooking appliance. That is, by controlling a steam generator, a fan and/or a hot air source, for example, the cooking chamber atmosphere or the temperature in the cooking chamber is adjusted, in particular in accordance with target values and/or target profiles.

One aspect of the present disclosure provides that the cooking path has a cooking time associated with the target temperature profile, wherein a desired cooking time is adjustable based on which the cooking process is performed, in particular wherein the desired cooking time is performed by user input and/or selection. In this way, the cooking process and the cooking time can be influenced in a technically simple manner without having to accept losses in the quality of the cooking product.

Here, it may in particular be provided that the regulation of the at least one energy source takes place as a function of the desired cooking time such that the total energy to be introduced, which is predetermined by the selected cooking path, is achieved in the desired cooking time. It is thus ensured that the desired cooking result is present at the desired time, i.e., neither too late nor too early. The cooking appliance, in particular the processor of the cooking appliance, thus processes the information such that the components, in particular the energy sources, are controlled such that the total energy to be introduced is introduced in the desired cooking time.

It is conceivable that a minimum cooking time is offered and/or displayed to a user as a default selection. The minimum cooking time may in particular be a time below which quality losses of the internal or external doneness occur. In particular, the minimum cooking time may depend on the type of cooking product, the caliber of the cooking product, and the thermal conductivity of the cooking product.

If the desired cooking time is below a technically possible cooking time, i.e. below the minimum cooking time which guarantees the desired cooking result, a warning message is output and/or the input is not accepted. This gives a user direct feedback that the desired cooking time is below the technically possible cooking time, i.e. below the minimum cooking time. Either the user then selects a different cooking path, for example comprising a different degree of cooking and/or a different quantity, or the user increases the desired cooking time, in particular at least to the minimum cooking time.

Furthermore, if the minimum cooking time is specified, the user is directly provided with a recommended time as information.

In an embodiment of the method, at least one of the energy sources is a microwave source which has a higher penetration depth into the cooking product than the other energy source(s). Thus, in a technically simple manner, the core of the cooking product can be purposefully heated. In addition, the use of microwave sources, in particular semiconductor-based solid state microwave generators (SSMG), allows information to be obtained about the cooking product in the cooking chamber by detecting reverse and/or reflected microwaves. This can be used to determine the energy absorption of the cooking product, in particular the absorption of the energy introduced by the microwave source.

To accelerate the cooking process, it may be provided in the process that the energy fraction of the microwave source in the total energy is increased if an acceleration of the cooking process is desired. In this way, faster heating of the cooking product core can be achieved, as the energy is introduced closer to the core, i.e. with a greater penetration depth. Among other things, time is saved that would otherwise have to be spent on heat conduction in the direction of the cooking product core. In addition, it is ensured that only the cooking product core absorbs this energy, which enables a purposeful cooking of the cooking product.

In particular, the energy fraction of the microwave source in the total energy is greater than a predetermined standard value of the cooking path if the desired cooking time is shorter than the cooking time predetermined by the cooking path, which is assigned to the target temperature profile, preferably wherein the energy fraction of the microwave source in the total energy is maximized if a minimum cooking time is provided as the desired cooking time. In this way, a particularly time-efficient cooking process can be realized.

A further aspect of the present disclosure provides that a ratio of the respective energy fractions of the energy sources in the total energy is variable, in particular wherein the energy sources each have an energy fraction predetermined by the cooking path for a cooking time predetermined by the cooking path. A simple and accurate process control is thus achieved.

Furthermore, it may be provided that a deviation of the actual temperature of the core temperature detected from the target temperature profile of the core temperature causes an energy source having a lower penetration depth to be controlled such that the energy fraction thereof in the total energy increases. Alternatively, an energy source having a higher penetration depth is controlled such that the energy fraction thereof in the total energy is reduced.

Thus, in the first case, the increased core temperature results in an increase in the energy of the energy source having a lower penetration depth. This also accelerates the reaching of the desired external doneness, so that the internal doneness and the external doneness have the desired state at the same time. The overall result is therefore a faster cooking process.

Alternatively, the increased core temperature can result in a reduction of the energy of the energy source having a higher penetration, such as the microwave source. Due to the reduction, the core temperature is again adapted to the target value or the core temperature adjusts to the target temperature profile of the core temperature. The cooking time predetermined by the cooking path is maintained.

Furthermore, it may be provided that the total energy and/or an energy amount ratio of the different energy sources is determined on the basis of a desired cooking result and/or a cooking product caliber. Consideration of these parameters enables a more precise process control and improves the quality of the cooking result.

Furthermore, the object is achieved according to the present disclosure by a cooking appliance having a cooking chamber, at least two different energy sources and a control and/or regulating unit which is configured and set up to carry out a method according to the present disclosure.

The advantages and features discussed with respect to the method of course also apply to the cooking appliance according to the present disclosure in a corresponding manner, which is why reference is made thereto.

### BRIEF DESCRIPTION OF THE DRAWINGS

Further features and advantages of the present disclosure will become apparent from the description below and from the drawings, to which reference is made and in which:

FIG. 1 shows a schematic representation of a cooking appliance according to the present disclosure, which in the example shown is loaded with a one-piece cooking product;

FIG. 2 shows a representation in which a target temperature profile, a previous actual temperature profile and an intended future temperature profile of a cooking product core, a target heating power profile, a previous actual heating power profile and an intended future heating power profile of a microwave source, a target browning profile, a previous actual browning profile and an intended future browning profile of a cooking product surface and a previous actual temperature profile and an intended future temperature profile of a cooking chamber are plotted against a cooking time; and

FIG. 3 shows a further representation in which a target temperature profile as well as an effective actual temperature profile of a cooking product core are plotted against a cooking time range.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

For the purposes of the present disclosure, the phrase “at least one of A, B, and C”, for example, means (A), (B), (C), (A and B), (A and C), (B and C), or (A, B, and C), including all further possible permutations when more than three elements are listed. In other words, the term “at least one of A and B” generally means “A and/or B”, namely “A” alone, “B” alone or “A and B”.

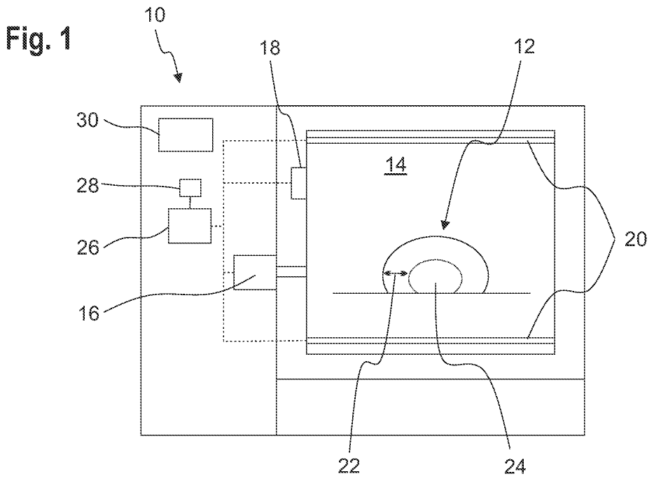

FIG. 1 shows a cooking appliance 10 for cooking a cooking product 12. The cooking appliance 10 comprises a cooking chamber 14, at least one microwave source acting as a first energy source 16, and a convection heating source acting as a second energy source 18. Alternatively or additionally, the cooking appliance 10 may have further energy sources, such as infrared heating sources 20.

In the example embodiment, the microwave source 16 comprises at least one semiconductor microwave generator (“solid state microwave generator” (SSMG)), which can generate microwaves, i.e. electromagnetic radiation. The microwaves may have a frequency at which they can penetrate the cooking product 12 to a depth of more than 1 cm, preferably 2 to 3 cm. Thus, the microwave source 16 has a corresponding penetration depth 22 that is greater than 1 cm, preferably 2 to 3 cm. For example, the frequency is between 2.1 GHz and 2.8 GHz, in particular about 2.4 GHz or 2.45 GHz. Due to the high penetration depth 22, it is possible to heat a cooking product core 24 and/or an area near the cooking product core 24 by means of the microwaves.

Of course, the microwave source 16 may include further components, such as a directional coupler, a modulator, an amplifier, a demodulator, and/or a regulator (not shown).

Alternatively to the semiconductor microwave generator, a magnetron may be provided to generate the microwaves.

The convection heating source 18, on the other hand, is configured to at least influence or form an atmosphere in the cooking chamber 14. This is possible as the convection heating source 18 heats the air in the cooking chamber 14. Additionally, a fan and/or steam generator may also be provided, as a result of which the air in the cooking chamber 14 may be circulated and/or the humidity thereof adjusted, thereby adjusting the cooking atmosphere. In a simple example embodiment, the convection heating source 18 may merely heat the air in the cooking chamber 14 to adjust the cooking atmosphere. As the cooking product 12 has its surface exposed to the atmosphere, the convection heating source 18 can be used to heat in particular the cooking product surface and/or the crust of the cooking product 12.

By means of an optionally provided infrared heating source 20, in particular areas of the cooking product 12 close to the surface can be heated up to a penetration depth 22 of a few millimeters. In the example embodiment shown, two infrared heating sources 20 are provided, which are assigned to opposite sides of the cooking chamber 14, namely to a bottom and a top of the cooking chamber 14 to heat the inserted cooking product 12 from its underside and its upper side.

In principle, the infrared heating source 20 has a smaller penetration depth 22 than the microwave source 16, but a larger penetration depth 22 than the convection heating source 18.

Of course, the convection heat source 18 and the optional infrared heat source 20 can also be used to heat the cooking product core 24. However, this requires a longer period of time compared to the use of the microwaves, as the thermal energy is first introduced further outside in the cooking product 12 and must first spread toward the cooking product core 24 due to thermal conduction.

Furthermore, the cooking appliance 10 comprises a control and/or regulating unit 26, a processor unit (not shown) a memory 28 and an input and output device 30, in particular a (touch-sensitive) screen.

The processor unit may be part of the control and/or regulating unit 26.

In the example embodiment, a computer program with program code means is stored in the memory 28. When executed by the processor unit of the cooking appliance 10, the computer program causes the control and/or regulating unit 26 to perform a method of cooking a cooking product 12 using at least two different energy sources 16, 18. This method will be described in more detail below. Accordingly, the program code means are converted by the control and/or regulating unit 26 into control commands for the components of the cooking appliance 10.

At the beginning of the method, a cooking product 12 is introduced into or is already present in the cooking chamber 14 of the cooking appliance 10.

In a first step of the method, a cooking path is selected by means of which the cooking product 12 is to be cooked.

In particular, the selection may be made by a user, for example by the user making inputs by means of the input and output device 30.

In the present case, the selected cooking path comprises a total energy to be introduced which is to be introduced into the cooking product 12 by the at least two different energy sources 16, 18. That is, the selection of the cooking path has the effect of determining a total energy to be introduced which has to be introduced into the cooking product 12 to obtain a desired cooking result associated with the selected cooking path.

The total energy and the fractions of the various energy sources 16, 18 can be stored in the memory 28 as default values and retrieved as a function of the desired cooking result and an existing cooking product caliber.

The cooking product caliber can be specified in particular by the mass, the volume and the shape of the cooking product 12. It can be specified by the user or determined by sensors, for example by evaluating microwaves by means of the semiconductor microwave source 16 in a sensor mode, in particular evaluating forward and backward waves.

If, for example, a thin cooking product 12 is cooked in which a pronounced crust formation is desired, it may be advantageous to introduce a high fraction of the necessary total energy by means of the convection heating source 18. An increased heating of the cooking product surface can thus be achieved, which leads to water evaporation from the cooking product surface and thus to the desired crust formation.

If, on the other hand, a comparatively thick cooking product 12 is cooked and/or less crust formation is desired, it may be provided that the necessary total energy is provided predominantly by the microwave source 16, for example to heat the cooking product core 24 as quickly as possible.

The ratio of the respective energy fractions of the energy sources 16, 18 to each other or to the total energy may be variable and change during the cooking process.

In any case, this may be stored in the selected cooking path.

Furthermore, the cooking path comprises a target temperature profile 32 of the cooking product core 24, which may also be stored in the memory 28. Similar to the total energy input, the target temperature profile 32 may also be dependent on the type of cooking product 12, the caliber of the cooking product, and the desired cooking result.

The target temperature profile 32 can also be correlated with the ratio of the energy fractions. If, for example, a rapid increase in the core temperature is provided according to the target temperature profile 32, this can be achieved by a high temporary or continuous heating power of the microwave source 16.

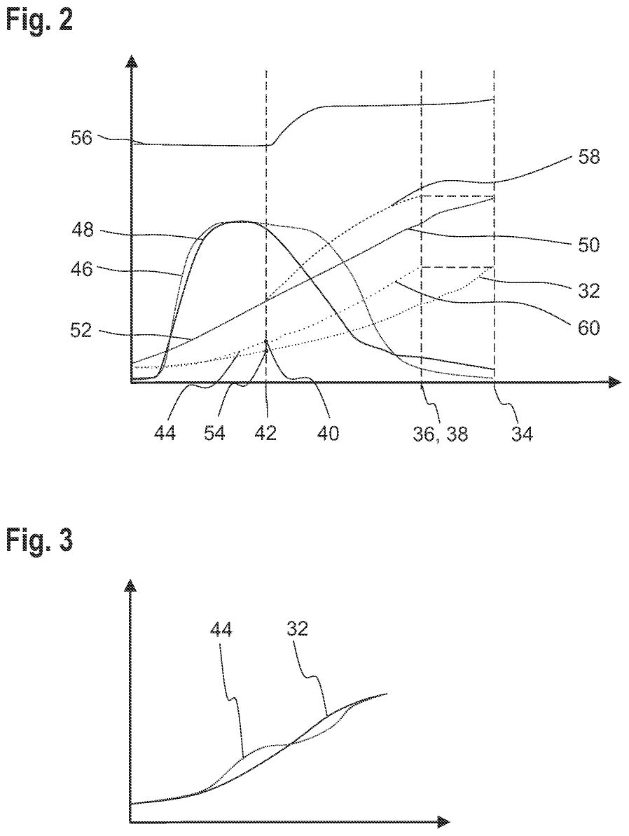

FIG. 2 shows a diagram in which, among other things, a possible target temperature profile 32 for the cooking product core 24 of the cooking product 12 is shown schematically over the cooking time.

FIG. 2 also shows an intended cooking time 34, which is assigned to the target temperature profile 32 and marks the end point thereof. In this respect, a desired cooking product core temperature is defined by the target temperature profile 32 and the cooking time 34.

The cooking time 34 can, for example, be predetermined by the cooking path. In the example embodiment, this is also a value that can be retrieved from the memory 28.

It may also be provided that the control and/or regulating unit 26 calculates a minimum cooking time 36 based on user inputs and/or a cooking product characterization, which is offered to the user for selection by means of the input and output device 30. In this context, the cooking product characterization may be performed, for example, by evaluating the microwaves by means of the semiconductor microwave source 16.

If the user input indicates that the desired cooking time 38 is shorter than the cooking time 34 provided by the cooking path, an energy fraction of the microwave source 16 in the total energy may be provided that is greater than the default value provided by the cooking path. Preferably, the energy fraction of the microwave source 16 in the total energy is maximized when a minimum cooking time 36 is predetermined as the desired cooking time 38.

In principle, it may be provided that a default cooking path is stored in the memory 28, with the default cooking path being adjusted based on inputs from the user to obtain a modified cooking path to be processed during the cooking process.

This means that a desired cooking result, a differing quantity of cooking product 12 and/or other deviations in parameters may cause the stored standard cooking path to be modified, so that the modified cooking path corresponding to the selected cooking path is then selected on the basis of the corresponding inputs.

In the example embodiment, the cooking process is started following the cooking path selection.

During the running cooking process, an actual temperature 40 of the cooking product core 24 is determined in a second process step. This can be done, for example, by means of a core temperature thermometer. Alternatively or additionally, the core temperature can also be determined by evaluating the microwaves, for example by using known temperature- and/or cooking-state-dependent microwave absorption values, or absorption coefficients, and comparing them with the actually determined microwave absorption in the cooking product 12. It can thus be concluded how much energy, in particular how much of the energy introduced by the microwave source 16, is absorbed by the cooking product core 24, which enables a conclusion to be drawn about the core temperature.

Preferably, the actual temperature 40 of the cooking product core 24 is determined at a plurality of different times, for example at predetermined time intervals, or continuously or periodically during the cooking process. This can be done by repeating step 2 several times over the entire duration of the cooking process. For simplicity, FIG. 2 shows only a determination point 42 and the actual temperature profile 44 of the cooking product core 24 actually achieved so far in the cooking process.

In a third process step, at least one of the energy sources 16, 18 is regulated on the basis of the target temperature profile 32 of the core temperature and the actual temperature 40 of the cooking product core 24. Of course, the regulation need not be limited to one energy source 16, 18. Preferably, all energy sources 16, 18 involved in the cooking process are regulated.

In this case, the regulation is carried out taking the total energy to be introduced into account such that the total energy to be introduced is maintained. It is thus ensured that the desired external doneness as well as the desired internal doneness of the cooking product 12 is achieved.

In the example embodiment, it is further provided that the regulation of the energy sources 16, 18 is performed taking the desired cooking time 38 into account, more specifically such that the total energy to be introduced, which is predetermined by the selected cooking path, is introduced into the cooking product 12 in the desired cooking time 38.

FIG. 2 shows, in addition to the core temperature profiles 32, 44, a target heating power profile 46 of the microwave source 16 by means of which the target temperature profile 32 of the cooking product core 24 can be adjusted. The target heating power profile 46 may also be a standard value included in the cooking path, which can be retrieved from the memory 28.

Furthermore, FIG. 2 shows an actual heating power profile 48 of the microwave source 16 actually introduced so far, as well as a target browning profile 50 and a previous actual browning profile 52 over the cooking time. The browning profiles 50, 52 may in particular be representations of color changes of the cooking product surface or a profile of an amount of liquid evaporated from the cooking product 12 over the cooking time.

If it is determined in method step 2 that an existing actual temperature 40 of the cooking product core 24 differs upwardly from the current target temperature 54, one of the energy sources 18 having a lower penetration depth 22 is controlled such that the energy fraction thereof in the total energy increases.

In the example embodiment, this is caused by an increase in the heating power of the convection heating source 18, which in turn leads to an increase in the cooking chamber temperature 56.

As a result, the evaporation of water from the cooking surface also increases, which accelerates the browning. This results in an intended future browning profile 58 in the example embodiment, which is above the target browning profile predetermined by the cooking path.

In this example, the intended future profile 60 of the core temperature of the cooking product 12 may also be above the target temperature profile 32 of the cooking path, as the deviation between the actual temperature 40 and the target temperature 54 of the cooking product core 24 detected in step 2 was not counteracted, but rather the energy source 18 responsible for the external doneness was readjusted.

As a result, the desired external doneness and the internal cooking state are achieved simultaneously, more specifically at the time when the desired short cooking time 38 is reached. In other words, the cooking process is accelerated.

Alternatively, the deviation of the actual temperature 40 of the cooking product core 24 from the current target temperature 54 detected in method step 2 may result in a control of an energy source 16 having a higher penetration depth 22 such that the energy fraction thereof in the total energy is reduced.

In the example embodiment, this is achieved by reducing the heating power of the microwave source 16. This counteracts the detected core temperature deviation. This process is shown in FIG. 3 on the basis of the target temperature profile 32 and the actual temperature profile 44 of the cooking product core 24. The actual temperature profile 44 can be regulated, for example, by means of a fractional controller, an integral controller, a fractional/integral controller or comparable controller.

As a result, the cooking process is continued such that the actual core temperature profile 44 corresponds to a good approximation of the target temperature profile 32. This is shown by way of example in FIG. 3, from which it is apparent that the microwave source 16 is always regulated to adapt the temperature profile of the core temperature to the target temperature profile 32.

The same applies to the target browning profile 50 and the actual browning profile 52. The desired external doneness and the internal doneness are also achieved simultaneously in this case, more specifically at the time originally predetermined according to the cooking path.

Likewise, however, it can also be determined that the actual core temperature of the cooking product core 24 is below the target temperature profile 32. In that case, the power of the convection heating source 18 may be reduced, thereby extending the cooking time accordingly so that the total energy to be introduced is achieved while ensuring that the internal doneness and the external doneness are achieved simultaneously.

Alternatively, it may be provided that the microwave source 16 is regulated such that the power is increased so that relatively more energy is introduced into the cooking product 12 by the microwave source 16. To ensure that the total energy is still maintained, the power of the convection heating source 18 is then reduced. The previously defined cooking time can be maintained in that case.

In principle, two options are thus available in the regulation, as either the cooking time is changed, for example shortened or lengthened, to maintain the originally set energy ratio of the energy fractions of the at least two energy sources 16, 18, or the ratio of the energy fractions of the at least two energy sources 16, 18 is changed to maintain the originally set cooking time.

For example, the user can set at the beginning whether the desired cooking time is to be maintained if it corresponds at least to the minimum cooking time, whether the ratio of the energy fractions of the at least two energy sources 16, 18 defined at the beginning is to be maintained, or whether both the cooking time and the ratio of the energy fractions should be flexibly adjusted.

In any case, the total energy to be introduced predetermined by the selected cooking path is maintained.

Certain embodiments disclosed herein, particularly the respective station(s) and/or unit(s), utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about”, “approximately”, “near” etc., mean plus or minus 5% of the stated value.

1. A method of cooking a cooking product using at least two different energy sources for cooking the cooking product the energy inputs of which into the cooking product have different penetration depths, comprising the following steps:
selecting a cooking path by which the cooking product to be cooked is cooked, wherein the cooking path comprises a total energy to be introduced which is to be introduced into the cooking product by the at least two different energy sources, and wherein the cooking path comprises a target temperature profile of a cooking product core;
determining an actual temperature of the cooking product core during an ongoing cooking process; and
regulating at least one of the two energy sources on the basis of the at least one target temperature profile of the core temperature and the actual temperature of the core temperature, taking the total energy to be introduced into account, such that the total energy to be introduced is maintained.

2. The method according to claim 1, wherein the cooking path has a cooking time assigned to the target temperature profile, wherein a desired cooking time can be set, based on which the cooking process is carried out.

3. The method according to claim 2, wherein a specification of the desired cooking time is carried out by a user input and/or by selection.

4. The method according to claim 2, wherein the regulation of the at least one energy source takes place depending on the desired cooking time, so that the total energy to be introduced, which is predetermined by the selected cooking path, is achieved in the desired cooking time.

5. The method according to claim 2, wherein a minimum cooking time is offered and/or displayed to a user as a default selection.

6. The method according to claim 1, wherein at least one of the energy sources is a microwave source having a higher penetration depth into the cooking product than the other energy source.

7. The method according to claim 6, wherein the cooking path has a cooking time assigned to the target temperature profile, wherein a desired cooking time can be set, based on which the cooking process is carried out, wherein the energy fraction of the microwave source in the total energy is increased when an acceleration of the cooking process is desired.

8. The method according to claim 7, wherein the energy fraction of the microwave source in the total energy becomes larger than a predetermined standard value of the cooking path when the desired cooking time is shorter than the cooking time predetermined by the cooking path and associated with the target temperature profile.

9. The method according to claim 8, wherein the energy fraction of the microwave source in the total energy is maximized when a minimum cooking time is provided as the desired cooking time.

10. The method according to claim 1, wherein a ratio of the respective energy fractions of the energy sources in the total energy is variable, in particular wherein the energy sources each have an energy fraction predetermined by the cooking path for a cooking time predetermined by the cooking path.

11. The method according to claim 1, wherein a deviation of the actual temperature of the core temperature detected from the target temperature profile of the core temperature causes an energy source having a lower penetration depth to be regulated such that the energy fraction thereof in the total energy increases, or an energy source having a higher penetration depth to be regulated such that the energy fraction thereof in the total energy decreases.

12. The method according to claim 1, wherein the total energy and/or an energy amount ratio of the different energy sources is determined on the basis of a desired cooking result and/or a cooking product caliber.

13. A cooking appliance comprising a cooking chamber, at least two different energy sources and a control and/or regulating unit which is configured and set up to perform a method according to claim 1.
